(19) United States
(12) Patent Application Publication
(10) Pub. No.: US 2020/0189976 A1
(43) Pub. Date: Jun. 18, 2020

(54) METHOD FOR MANUFACTURING A NATURALLY COOLING CERAMIC RECEPTACLE

(71) Applicant: MAGISSO OY, Helsinki (FI)

(72) Inventor: Simon Stevens, Greenwich London (GB)

(21) Appl. No.: 16/482,598

(22) PCT Filed: Feb. 1, 2018
(86) PCT No.: PCT/FI2018/050075

§ 371 Date: Jul. 31, 2019

(30) Foreign Application Priority Data
Feb. 3, 2017 (FI) 20175096

(51) Int. Cl. C04B 33/04; C04B 33/30; C04B 33/34; C04B 33/13; C04B 33/14; C04B 33/16

(52) U.S. Cl. CPC C04B 33/04; C04B 33/30; C04B 33/34; C04B 33/131; C04B 33/14; C04B 2235/661; C04B 2235/349; C04B 2235/3418; C04B 2235/3217; C04B 2235/656; C04B 33/16

(57) ABSTRACT

A method for manufacturing a naturally cooling ceramic receptacle comprising preparing a clay body by adding ball clay and/or quartz, water and deflocculant, forming the clay body into a desired shape of the ceramic receptacle with molds by at least one of roller making, pressure casting and slip casting, demolding the formed clay body and drying at a temperature higher than a room temperature, performing a first firing of the clay body in a kiln at a temperature higher than 1050° C. to obtain a biscuit receptacle, mixing a slip casting clay with desired color pigments to produce plastic colored slip casting clay, dipping the biscuit receptacle into the colored slip casting clay and drying, and performing a second firing of the biscuit receptacle with the dried color slip casting clay in a kiln at a temperature higher than 1000° C. but lower than the temperature of the first firing.

The invention relates to a method for manufacturing a naturally cooling ceramic receptacle.

Such receptacles can be used for keeping beverages and food stuffs deliciously cool for longer times without need for freezer, fridge or ice cubes. The effect of natural cooling is based on porosity of the ceramic material. When the receptacle is immersed or soaked in water, water is sucked by capillary effect of the porous material throughout the thickness of the ceramic wall of the receptacle. Thereafter, in use of the receptacle, the water gradually evaporates from the ceramic wall, keeping the receptacle cool.

The naturally cooling ceramic receptacles have been known for a long time as terracotta or grey clay (ceramic) receptacles. So far it has been difficult to manufacture colored receptacles with effective natural cooling. The slip casting clay with color pigments has tendency to fill and block the capillary pores during firing the slip casting clay in a kiln. Particularly, behavior of the color pigment crystals in a high temperature causes the tendency to fill and block the capillary pores.

The aim of the present invention is to resolve the above mentioned problem by a method which retains the capillary porosity of the finalized ceramic material despite of using desired color pigments in the slip casting clay which is used to cast a colored surface mantle of the receptacle.

This aim can be fulfilled with the method according to the method steps of the enclosed claim 1. Dependent claims define advantageous embodiments of the invented method.

The invented method and its embodiments will be described in the following in more detail.

The method comprises the following steps.

First step is preparing a clay body by adding ball clay (kaolin) and/or quartz (talk) and water and deflocculant (sodium silicate for slip casting clays). Formulation changes/varies depending on the next forming step. Forming the clay body into a desired shape of the ceramic receptacle can be made with molds by at least one of the following forming methods: roller making, pressure casting and slip casting.

The formed clay body is demolded and dried for several hours at a temperature higher than the room temperature. The drying time may be 24 hours and temperature 50° C.

A first firing of the formed and dried clay body is performed in a biscuit kiln in a temperature higher than 1050° C. to obtain a biscuit receptacle. The temperature of the first firing is preferably higher than 1100° C., and a preferred temperature of the first firing is between 1120-1160° C. The firing time required for the first firing is typically around 12 hours.

In many cases glazing is desired on the inner surface of the receptacle. This concerns the cases where the beverage or food stuff is in direct contact with the inner surface. It is also desirable to have glazing on the outer surface at the area close to the upper edge of the receptacle, in other words at the area where the lips contact when the receptacle is for drinking beverage. This area may be 2 cm high at the most, in order not to cover too much of the outer surface's effective area for cooling.

If glazing is used, then after the first firing the glazing material is applied on the inner surface of the biscuit receptacle for instance by dipping. Common recipe of glazing material is feldspar, silica, alumina, quartz and flux. The glazing material is dried and the glazed part of the biscuit receptacle is covered with protective wax for protection of the glazed part. The protective wax is burned during the second firing which is explained later.

Then the coloring process is performed as follows. A slip casting clay with desired color pigments is mixed to produce colored plastic clay for slip casting. All elements of the slip casting clay are put into a large container and mixed, filtered, pressed and plugged to produce colored plastic clay for slip casting. Recipe for a navy blue slip casting clay may be as follows: Cobalt Blue 13-14%, Vanadium Blue 2.5-2.9%, Cobalt Black 1.6-2.0%, Zirconium Silicate 5-7%, Feldspar 30-35%, Quartz 15-19%, Kaolin 24-28%.

The biscuit receptacle is dipped into the colored slip casting clay and immediate drying is performed. After the dipping and drying step but before performing a second firing of the biscuit receptacle (as explained later), the slip casting clay mantle with color pigments may be coated by spray painting. The spray painting has similar colors as the colors of the slip casting clay.

A second firing of the biscuit receptacle is performed with the dried color slip-casting clay thereon in a kiln in a temperature higher than 1000° C. but lower than the temperature of the first firing. A preferred temperature of the second firing is between 1040-1080° C. The previously applied protective wax for protection of the glazed part of the biscuit receptacle is burned during the second firing. The time of the second firing is around 8-12 hours.

The preferred product manufactured by the above described method is such that the inner surface of the receptacle has a glazed surface layer and the outer surface of the receptacle has a mantle of slip casted colored ceramic material having desired color with precisely selected color pigments.

If desired, an additional third firing may be used for applying a decal onto the receptacle at a desired location. The decal firing is performed at a temperature range of 750-850° C.

1. Method for manufacturing a naturally cooling ceramic receptacle, the method comprising the steps of
preparing a clay body by adding ball clay (kaolin), and optionally quartz (talk), and water and deflocculant
forming the clay body into a desired shape of the ceramic receptacle with molds by at least one of the following forming methods: roller making, pressure casting and slip casting
demolding the formed clay body and drying it for several hours at a temperature higher than a room temperature
performing a first firing of the formed and dried clay body in a kiln in a temperature higher than 1050° C. to obtain a biscuit receptacle
mixing a slip casting clay with desired color pigments to produce plastic colored slip casting clay
dipping the biscuit receptacle into the colored slip casting clay and performing immediate drying, and
performing a second firing of the biscuit receptacle with the dried color slip casting clay thereon in a kiln in a temperature higher than 1000° C. but lower than the temperature of the first firing.

2. A method according to claim 1, characterized in that the temperature of the first firing is between 1120-1160° C. and the temperature of the second firing is between 1040-1080° C.

3. A method according to claim 1, wherein a glazing material is applied on the inner surface of the receptacle, characterized in that after the first firing the glazing material is applied on the inner surface of the biscuit receptacle, the glazing material is dried and covered with protective wax for protection of the glazed part of the biscuit receptacle, the protective wax being burned during the second firing.

4. A method according to claim 3, characterized in that the glazing material includes feldspar, silica, alumina, quartz and flux.

5. A method according to claim 1, characterized by an additional third firing for applying a decal onto the receptacle, the decal firing being performed at a temperature range of 750-850° C.

6. A method according to claim 1, characterized in that the colored slip casting clay contains Cobalt Blue 13-14%, Vanadium Blue 2.5-2.9%, Cobalt Black 1.6-2.0%, Zirconium Silicate 5-7%, Feldspar 30-35%, Quartz 15-19%, Kaolin 24-28%.

7. A method according to claim 1, characterized in that the mixing phase of the colored slip casting clay includes the steps of filtering, pressing and pugging.

8. A method according to claim 1, characterized in that after the dipping and drying step but before performing a second firing of the biscuit receptacle, the slip casting clay mantle with color pigments is coated by spray painting.

9. A naturally cooling ceramic receptacle which is made by a method according to claim 1.

10. A method according to claim 3, characterized in that the inner surface of the receptacle has a glazed surface layer and the outer surface of the receptacle has a mantle of slip casted colored ceramic material.
